(19) United States
(12) Patent Application Publication
(10) Pub. No.: US 2009/0302594 A1
(43) Pub. Date: Dec. 10, 2009

(54) INTEGRATED DEVICE AND METHOD FOR RECORDING IDENTIFICATION INFORMATION

(76) Inventors: Thomas D. RAY, III, Birmingham, AL (US); Jay MULLALY, Birmingham, AL (US); Robert J. ALDEN, Birmingham, AL (US)

Correspondence Address: DYKEMA GOSSETT PLLC, 39577 WOODWARD AVENUE, SUITE 300, BLOOMFIELD HILLS, MI, 48304-5086, US

(21) Appl. No.: 12/477,732

(22) Filed: Jun. 3, 2009

Related U.S. Application Data
(60) Provisional application No. 61/058,976, filed on Jun. 5, 2008.

(51) Int. Cl. B42D 15/00

(52) U.S. Cl. 283/69; 283/78

(57) ABSTRACT

An integrated device and method for recording identification information is provided according to embodiments disclosed herein. The integrated device includes a fingerprint surface provided with an ink layer on a first side; and a DNA collection surface operatively configured to be secured with a film.

### CROSS REFERENCE TO RELATED APPLICATIONS

This application claims the filing date benefit of application Ser. No. 61/058,976, filed on Jun. 5, 2008, the contents of which are hereby incorporated by reference.

### BACKGROUND

The present disclosure relates generally to recording and preserving of biometric identification data, and more particularly to recording and preserving fingerprint and DNA information.

It is desirable to maintain accurate and long-lasting records of biometric information for a variety of purposes. Such information is often critical for criminal and missing persons investigations. Recording and preserving fingerprints is traditionally accomplished by pressing a finger onto an ink pad, then applying the ink laden finger to paper to leave a print.

Often a law enforcement or other investigative officer may require fingerprints and DNA sampling to be taken in an area or at a site that is far away from ideal or typical resources for extracting or analyzing such data. Existing solutions to gathering such information, especially with regard to fingerprints, are unsatisfactory.

Gathering fingerprint information generally requires the provision of at least a number of items, including the step of providing an ink pad. Traditional processes also include the cumbersome steps applying the fingers to be sampled first to an ink pad.

Furthermore, gathering a DNA sample, such as hair or skin, will require additional items for gathering and storing such a sample. Existing solutions to gathering fingerprint and DNA information are also unsatisfactory due to the need to separately collect and catalog such information. For example, samples of DNA and fingerprints must be separately labeled and stored in separate media. However, the various means of storing the DNA or fingerprints may cause confusion or cause the samples to become separated.

In addition to fieldwork investigations, fingerprint and DNA collection is also desirable for parents and guardians in maintaining the safety and security of minor children. There is a need to obtain and retain in information that uniquely identifies an individual, particularly a minor child, in case that individual is ever missing or injured and needs to be found or identified. In particular, a number of commercial systems have been developed for quickly and easily fingerprinting individuals, such as family members, for subsequent identification purposes. Other commercial systems are provided for utilizing fingerprints for document protection systems, or for associating individuals by photographs and/or fingerprint, with negotiable instruments. However, the traditional systems and methods for such data collection have complexities, lack versatility and/or expense that limit their applicability to a number of different situations.

Accordingly, the traditional fingerprint gathering solutions are highly unsatisfactory for use in fieldwork where work space is limited or in a home where data collection systems are generally unavailable. Furthermore, when DNA and fingerprint data is gathered in fieldwork or in a home, a user strongly desires a data collection system and method that is quick, simple and efficient.

### SUMMARY

An integrated device and method for recording identification information is provided according to embodiments disclosed herein. The integrated device includes a fingerprint surface provided with an ink layer on a first side; and a DNA collection surface operatively configured to be secured with a film.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a front view of an embodiment of an integrated device for recording identification information;

FIG. 2 is back view of an embodiment of an integrated device for recording identification information;

FIG. 3 is a flow chart illustrating a first embodiment of a method for recording identification information.

FIG. 4 is a flow chart illustrating a second embodiment of a method for recording identification information.

FIG. 5 is a flow chart illustrating a third embodiment of a method for recording identification information.

### DETAILED DESCRIPTION

The present disclosure provides an integrated device 10 and method for recording identification information which is efficient, quick and simple. The integrated device 10 and method for recording identification information disclosed herein substantially and advantageously overcomes at least the potential drawbacks noted in the background above.

The integrated device 10 includes a fingerprint surface 12 provided with an ink layer 14 on a first side 11; and a DNA collection surface 16 operatively configured to be secured with a film. It is to be understood that the application of a finger surface to the ink layer 14 removes contacted ink and leaves a lightened area depicting the fingerprint. A removeable film layer 26 is provided to the first side 11. The removeable film layer 26 protects the ink layer 14 prior to use. It is to be understood that the removeable film layer 26 may be discarded just prior to the collection of fingerprint samples and/or DNA samples.

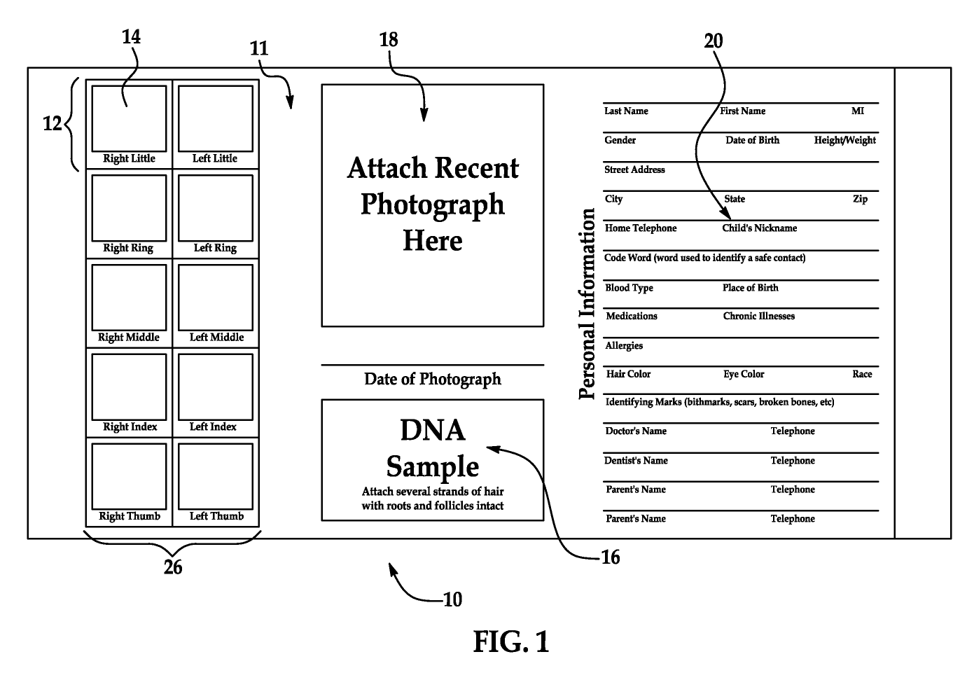

It is also to be understood that the removeable film disposed on the first side 11 of the integrated device 10 may be made a transparent polymeric material. The removeable film may consist of one piece or multiple pieces on the first side 11. In one non-limiting example, the removeable film consists of one piece, the removeable film may cover the entire first side 11 of the integrated device 10 and be co-extensive with the first side 11 of the integrated device 10. In yet another non-limiting example, the removeable film may consist of one piece and may cover a portion of the first side 11 of the integrated device 10 as shown in FIG. 1. In yet a third non-limiting example, the removeable film may consist of multiple pieces so that a first piece covers one or more of the fingerprint surface areas 12, and a second piece covers the DNA collection surface 16 area.

Referring again to FIG. 1, the first side 11 may further include a photograph area 18 and a personal information area 20. The photograph area 18 may be a designated area on the first surface 11 or on the second surface 25 to affix a photograph of the individual associated with the fingerprints and/or DNA sample (not shown). The personal information area 20 is a designated area on a first surface 11 or the second surface 25 of the integrated device 10 where a user may include text relating to the DNA samples and/or fingerprints.

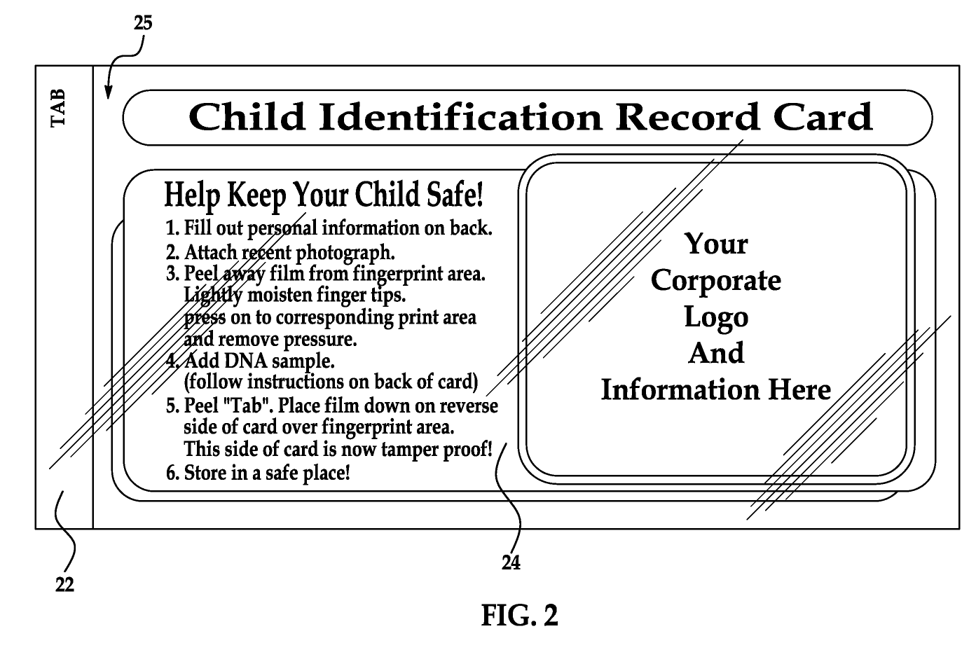

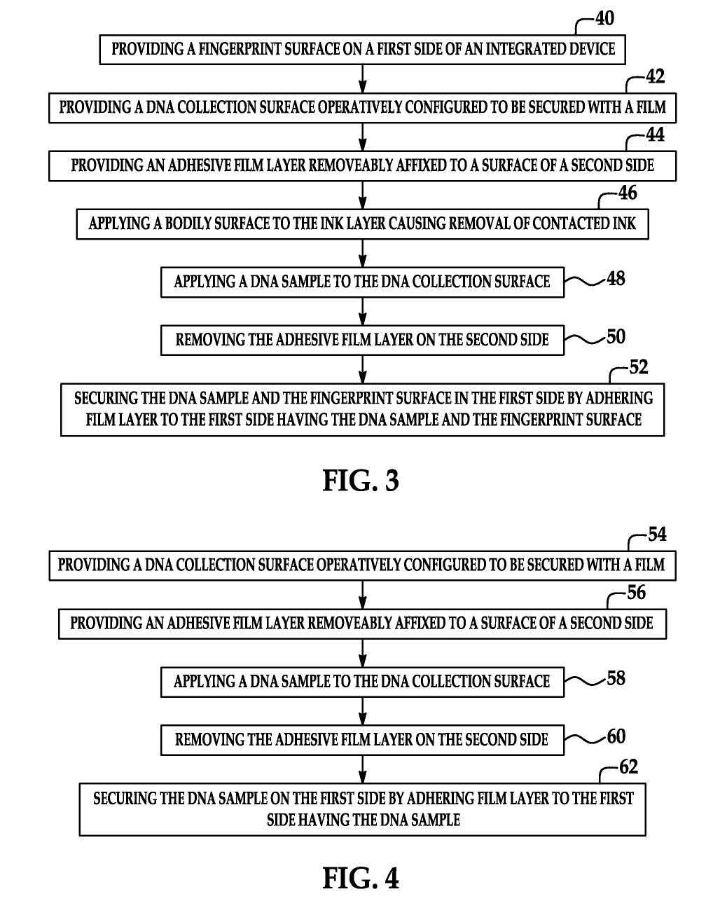

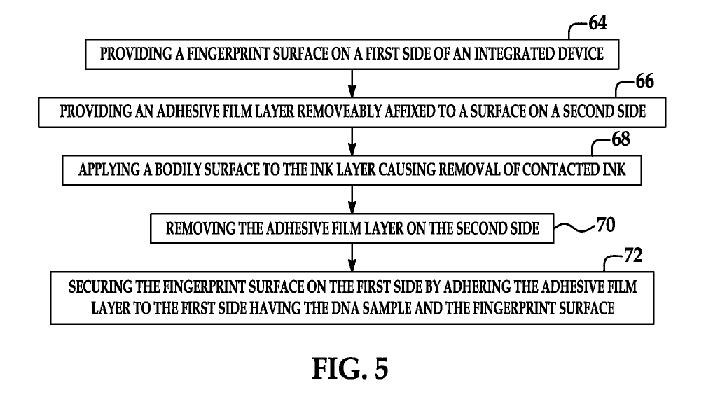

Referring now to FIG. 2, on the second side 25 of the integrated device 10 for recording identification information, an adhesive film may be removeably affixed on the second side 25 of the device may be provided. The adhesive film is operatively configured to be removed from the second side 25 of the device and then subsequently adhered to the first side 11 of the device to secure the fingerprints on the fingerprint surface 12. It is also to be understood that where a DNA sample is collected and provided on a DNA collection surface 16 on the first side 11, the adhesive film may also be operatively configured to secure the DNA sample to the first side 11 of the device. In one non-limiting example, the adhesive film may be made of a transparent polymeric material.

In another embodiment of the present disclosure, the integrated device 10 may include a plurality of fingerprint surfaces 12, a DNA collection surface 16, and/or a personal data field (or personal information area 20 shown in FIG. 1) disposed on either a first side 11 or a second side 25 of the device and an adhesive film layer 24.

With respect to this embodiment, each of the fingerprint surfaces 12 includes an ink layer 14. The DNA collection surface 16 may be disposed on the first side 11 of the device. The adhesive film layer 24 is removeably affixed to a surface of a second side 25, the adhesive film layer 24 is operatively configured to be removed from the surface of the second side 25 and then subsequently attach to the surface of the first side 11 after at least one of the fingerprint surfaces 12 and the DNA collection surface 16 has been filled.

It is to be understood that the integrated device 10 of the present disclosure may further include an advertising area or a graphics area. The advertising area may include text which identifies the manufacturer of the integrated device 10. The graphics area of the present disclosure may include symbols or images which provides aesthetic appeal to a user. It is also to be understood that the graphics area may also identify the use and/or manufacturer of the integrated device 10.

The adhesive film layer 24 of the present disclosure is operatively configured to be removed from either the first side 11 or the second side 25 of the integrated device 10. The adhesive film layer 24, once removed, may include residual adhesives on the layer to allow the adhesive layer to be reattached to the first side 11 of the integrated device 10.

In order to facilitate the above removal of the adhesive layer, the adhesive layer may further include a tab 22 (which may contains no adhesive or which may extend beyond the boundaries of the second surface) to facilitate removal of the adhesive film layer 24 from the second side 25.

Given that the fingerprint is created through the removal of the ink in the ink layer 14 as the finger or bodily surface is applied to the ink layer 14, it is to be understood that the ink layer 14 may be a dark color such as, but not limited to, examples of black, brown or blue ink.

The present disclosure further provides a first embodiment for a method of recording identification information wherein the method includes the steps of: (1) providing a fingerprint surface on a first side of an integrated device, the fingerprint surface including an ink layer; 40 (2) providing a DNA collection surface operatively configured to be secured with a film; 42 (3) providing an adhesive film layer removeably affixed to a surface of a second side; 44 (4) applying a bodily surface to the ink layer causing removal of contacted ink; 46 (6) applying a DNA sample to the DNA collection surface; 48 (7) removing the adhesive film layer on the second side; 50 and (8) securing the DNA sample and the fingerprint surface on the first side by adhering the adhesive film layer to the first side having the DNA sample and the fingerprint surface 52.

The present disclosure further provides a second embodiment for a method of recording identification information. The second embodiment method includes the steps of: (1) providing a DNA collection surface operatively configured to be secured with a film; 54 (2) providing an adhesive film layer removeably affixed to a surface of a second side; 56 (3) applying a DNA sample to the DNA collection surface; 58 (4) removing the adhesive film layer on the second side; 60 and (5) securing the DNA sample on the first side by adhering the adhesive film layer to the first side having the DNA sample 62.

The present disclosure further provides a third non-limiting, example embodiment for a method of recording identification information. The second embodiment method includes the steps of: (1) providing a fingerprint surface on a first side of an integrated device, the fingerprint surface including an ink layer; 64 (2) providing an adhesive film layer removeably affixed to a surface of a second side; 66 (3) applying a bodily surface to the ink layer causing removal of contacted ink; 68 (4) removing the adhesive film layer on the second side; 70 and (5) securing the fingerprint surface on the first side by adhering the adhesive film layer to the first side having the DNA sample and the fingerprint surface. 72

While multiple embodiments have been described in detail, it will be apparent to those skilled in the art that the disclosed embodiments may be modified. Therefore, the foregoing description is to be considered exemplary rather than limiting.

What is claimed is:

1. An integrated device for recording identification information for collecting and recording fingerprints, the integrated device comprising:
a fingerprint surface provided with an ink layer on a first side;
and a DNA collection surface operatively configured to be secured with a film.

2. The integrated device as defined in claim 1 wherein the application of a finger surface to the ink layer removes contacted ink and leaves a lightened area depicting the fingerprint.

3. The integrated device as defined in claim 1, further comprising a film layer which protects the ink layer prior to use.

4. The integrated device as defined in claim 1, further comprising an adhesive film removeably affixed on a second side of the device, the adhesive film capable of application over the fingerprint on the fingerprint surface after use to protect the resulting fingerprint.

5. An integrated device for recording identification information, the integrated device comprising:
a first side having a plurality of fingerprint surfaces, each of the fingerprint surfaces including an ink layer;
a DNA collection surface disposed on the first side;
a personal data field disposed on the first side;
an adhesive film layer removeably affixed to a surface of a second side, the adhesive film layer being operatively configured to attach to the surface of the first side after at least one of the fingerprint surfaces and the DNA collection surface has been filled.

6. The integrated device as defined in claim 5, further comprising an advertising area.

7. The integrated device as defined in claim 5, further comprising a graphics area.

8. The integrated device as defined in claim 5 wherein the adhesive film layer further includes a tab to facilitate removal of the adhesive film layer from the second side.

9. The integrated device as defined in claim 1 wherein the ink layer is black.

10. A method of recording identification information, the method comprising the steps of:
providing a fingerprint surface on a first side of an integrated device, the fingerprint surface including an ink layer;
providing a DNA collection surface operatively configured to be secured with a film;
providing an adhesive film layer removeably affixed to a surface of a second side;
applying a bodily surface to the ink layer causing removal of contacted ink;
applying a DNA sample to the DNA collection surface;
removing the adhesive film layer on the second side; and
securing the DNA sample and the fingerprint surface on the first side by adhering the adhesive film layer to the first side having the DNA sample and the fingerprint surface.

11. A method of recording identification information, the method comprising the steps of:
providing a DNA collection surface operatively configured to be secured with a film;
providing an adhesive film layer removeably affixed to a surface of a second side;
applying a DNA sample to the DNA collection surface;
removing the adhesive film layer on the second side; and
securing the DNA sample on the first side by adhering the adhesive film layer to the first side having the DNA sample.

12. A method of recording identification information, the method comprising the steps of:
providing a fingerprint surface on a first side of an integrated device, the fingerprint surface including an ink layer;
providing an adhesive film layer removeably affixed to a surface of a second side;
applying a bodily surface to the ink layer causing removal of contacted ink;
removing the adhesive film layer on the second side; and
securing the fingerprint surface on the first side by adhering the adhesive film layer to the first side having the DNA sample and the fingerprint surface.
